(19) United States
(12) Patent Application Publication
(10) Pub. No.: US 2021/0149593 A1
(43) Pub. Date: May 20, 2021

(54) Core Controller Architecture

(71) Applicant: SanDisk Technologies, LLC, Addison, TX (US)

(72) Inventor: Vijay Chinchole, Bangalore (IN)

(21) Appl. No.: 16/687,086

(22) Filed: Nov. 18, 2019

(51) Int. Cl. G06F 3/06

(52) U.S. Cl. CPC G06F 3/0659; G06F 3/0626; G06F 3/0653; G06F 3/0679

(57) ABSTRACT

A data storage system includes a storage controller and a storage medium in communication with the storage controller. The storage medium includes a memory core comprising an array of memory cells and core control logic configured to perform operations on memory cells in the array in accordance with instructions received from the storage controller. The core control logic comprises a firmware-implemented condition evaluation machine configured to determine whether a plurality of memory core conditions are met. The core control logic also comprises a firmware-implemented signal setting machine configured to set or reset a plurality of respective memory operation signals to implement the operations on the memory cells based on respective condition evaluation machine determinations.

### TECHNICAL FIELD

The present disclosure relates to data storage systems, and in particular, to a firmware implementation of a core controller.

### BACKGROUND

Non-volatile memories, such as flash memory devices, have supported the increased portability of consumer electronics, and have been utilized in relatively low power enterprise storage systems suitable for cloud computing and mass storage. The ever-present demand for almost continual advancement in these areas is often accompanied by demand for improved data storage capacity and greater performance (e.g., quicker reads and writes). Improved storage capacity allows for decreased form factor of the storage device. However, as the form factor continues to decrease, reworking storage devices after they have been manufactured (e.g., as part of a debugging process) becomes increasingly difficult. There is ongoing pressure to make storage devices smaller without losing the ability to debug and change the hardware after it has been manufactured.

### SUMMARY

This application describes various implementations of a storage medium controller including firmware-implemented modules which have traditionally been implemented using hardwired logic. Post-manufacturing changes are easier to implement in firmware implementations than in hardwired logic implementations. Various implementations of systems, methods and devices within the scope of the appended claims each have several aspects, no single one of which is solely responsible for the desirable attributes described herein. Without limiting the scope of the appended claims, some prominent features are described. After considering this discussion, and particularly after reading the section entitled “Detailed Description” one will understand how the features of various implementations are used to maintain the ability to make post-manufacturing adjustments with smaller storage device form factors.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram of a data storage system in accordance with some embodiments.

FIG. 2 is a block diagram of control logic modules in accordance with some embodiments.

FIG. 3A is a signal chart including signal levels and timing data in accordance with some embodiments.

FIG. 3B is a signal table capturing the signal levels and timing data of FIG. 3A in accordance with some embodiments.

FIG. 4 is a diagram of a processing architecture including a firmware-implemented signal module and a firmware-implemented condition module in accordance with some embodiments.

FIG. 5 is a diagram of a circuit for optimizing the architecture of FIG. 4 in accordance with some embodiments.

FIG. 6 is a diagram of a processing architecture for grouping the signals and conditions of the architecture of FIG. 4 in accordance with some embodiments.

FIG. 7A is a diagram of a processing architecture including a condensed version of the condition module of FIG. 6.

FIG. 7B is a diagram of an example implementation of the processing architecture of FIG. 7A in accordance with some embodiments.

FIG. 8 is a diagram of a processing architecture including a condensed version of the signal module of FIG. 6.

FIG. 9 is a diagram of a parallel processing architecture in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals are used to denote like features throughout the specification and figures.

### DETAILED DESCRIPTION

The various implementations described herein include systems, methods and/or devices that transmit data from a host to a storage system through an interface link optimized for performance.

Numerous details are described herein in order to provide a thorough understanding of the example implementations illustrated in the accompanying drawings. However, the invention may be practiced without many of the specific details. And, well-known methods, components, and circuits have not been described in exhaustive detail so as not to unnecessarily obscure more pertinent aspects of the implementations described herein.

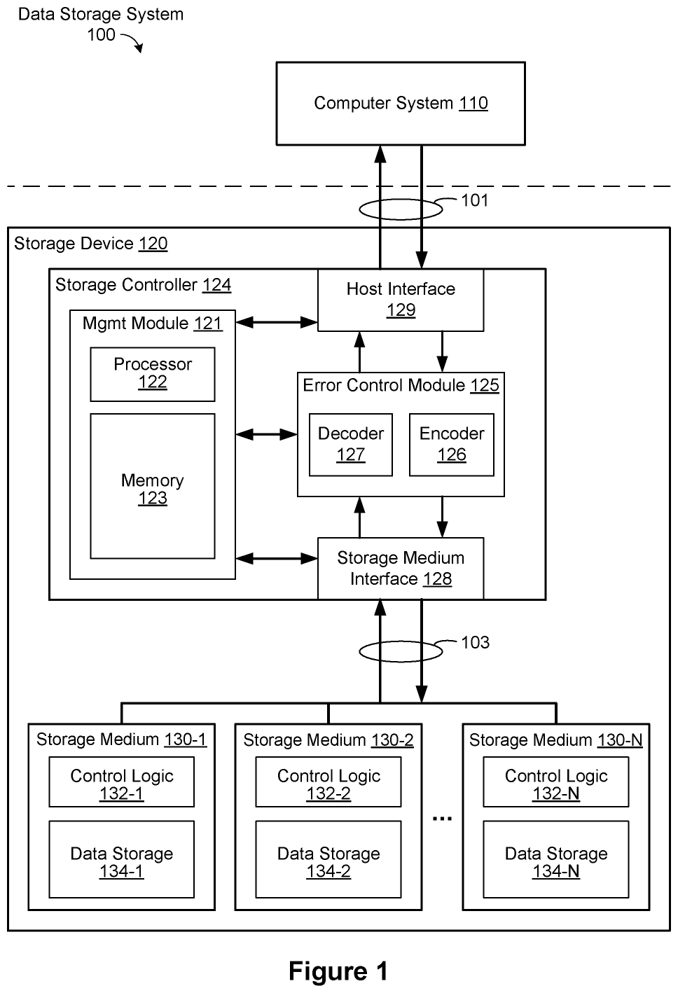

FIG. 1 is a diagram of an implementation of a data storage environment, namely data storage system 100. While certain specific features are illustrated, those skilled in the art will appreciate from the present disclosure that various other features have not been illustrated for the sake of brevity, and so as not to obscure more pertinent aspects of the example implementations disclosed herein. To that end, as a non-limiting example, the data storage system 100 includes a data processing system (alternatively referred to herein as a computer system or host) 110, and a storage device 120.

The computer system 110 is coupled to the storage device 120 through data connections 101. In various implementations, the computer system 110 includes the storage device 120 as a component. Generally, the computer system 110 includes any suitable computer device, such as a computer, a laptop computer, a tablet device, a netbook, an internet kiosk, a personal digital assistant, a mobile phone, a smart phone, a gaming device, a computer server, a peripheral component interconnect (PCI), a serial AT attachment (SATA), or any other computing device. In some implementations, the computer system 110 includes one or more processors, one or more types of memory, a display, and/or other user interface components such as a keyboard, a touch screen display, a mouse, a trackpad, a digital camera, and/or any number of supplemental devices to add functionality.

The storage device 120 includes one or more storage mediums 130 (e.g., N storage mediums 130, where N is an integer greater than or equal to 1). The storage medium(s) 130 are coupled to a storage controller 124 through data connections 103. In various implementations, the storage controller 124 and storage medium(s) 130 are included in the same device (e.g., storage device 120) as constituent components thereof, while in other embodiments, the storage controller 124 and storage medium(s) 130 are, or are in, separate devices. In some embodiments, the storage controller 124 is an application-specific integrated circuit (ASIC).

Each storage medium 130 includes control logic 132 and data storage 134. The data storage 134 may comprise any number (i.e., one or more) of memory devices including, without limitation, non-volatile semiconductor memory devices, such as flash memory. Flash memory devices can be configured for enterprise storage suitable for applications such as cloud computing, and/or configured for relatively smaller-scale applications such as personal flash drives or hard-disk replacements for personal, laptop and tablet computers.

In some implementations, the storage controller 124 includes a management module 121, an error control module 125, a storage medium interface 128, and a host interface 129. The host interface 129 couples the storage device 120 and its storage controller 124 to one or more computer systems 110, while the storage medium interface 128 couples the storage controller 124 to the storage medium(s) 130. In some implementations, the storage controller 124 includes various additional features that have not been illustrated for the sake of brevity, and so as not to obscure more pertinent features of the example implementations disclosed herein. As such, a different arrangement of features may be possible.

The host interface 129 typically includes data buffers (not shown) to buffer data being received and transmitted by the storage device 120 via the data connections 101. Similarly, the storage medium interface 128 provides an interface to the storage medium(s) 130 though the data connections 103. In some implementations, the storage medium interface 128 includes read and write circuitry.

The error control module 125 is coupled between the storage medium interface 128 and the host interface 129. In some implementations, the error control module 125 is provided to limit the number of uncorrectable errors inadvertently introduced into data. To that end, the error control module 125 includes an encoder 126 and a decoder 127. The encoder 126 encodes data to produce a codeword which is subsequently stored in a storage medium 130. When the encoded data is read from the storage medium 130, the decoder 127 applies a decoding process to recover the data and correct errors within the error correcting capability of the error control code. Various error control codes have different error detection and correction capacities, and particular codes are selected for various applications.

The management module 121 typically includes one or more processors 122 (sometimes referred to herein as CPUs, processing units, hardware processors, processors, microprocessors or microcontrollers) for executing modules, programs and/or instructions stored in memory and thereby performing processing operations. However, in some implementations, the processor(s) 122 are shared by one or more components within, and in some cases, beyond the function of the storage controller 124. The management module 121 is coupled by communication buses to the host interface 129, the error control module 125, and the storage medium interface 128 in order to coordinate the operation of these components.

The management module 121 also includes memory 123 (sometimes referred to herein as controller memory), and one or more communication buses for interconnecting the memory 123 with the processor(s) 122. Communication buses optionally include circuitry (sometimes called a chipset) that interconnects and controls communications between system components. The controller memory 123 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The controller memory 123 optionally includes one or more storage devices remotely located from the one or more processors 122. In some embodiments, the controller memory 123, or alternatively the non-volatile memory device(s) within the controller memory 123, comprises a non-transitory computer readable storage medium. In some embodiments, the controller memory 123, or the non-transitory computer readable storage medium of the controller memory 123, stores the programs, modules, and/or data structures, or a subset or superset thereof, for performing one or more of the operations described in this application with regard to any of the components associated with the storage controller 124.

In some embodiments, the various operations described in this application correspond to sets of instructions for performing the corresponding functions. These sets of instructions (i.e., modules or programs) need not be implemented as separate software programs, procedures or modules, and thus various subsets of these modules may be combined or otherwise re-arranged in various embodiments. In some embodiments, the memory 123 may store a subset of modules and data structures. Furthermore, the memory 123 may store additional modules and data structures. In some embodiments, the programs, modules, and data structures stored in the memory 123, or the non-transitory computer readable storage medium of the memory 123, provide instructions for implementing any of the methods described below. Stated another way, the programs or modules stored in the memory 123, when executed by the one or more processors 122, cause the storage device 120 to perform any of the operations described below. Although FIG. 1 shows various modules, FIG. 1 is intended more as functional description of the various features which may be present in the modules than as a structural schematic of the embodiments described herein. In practice, the programs, modules, and data structures shown separately could be combined, and some programs, modules, and data structures could be separated.

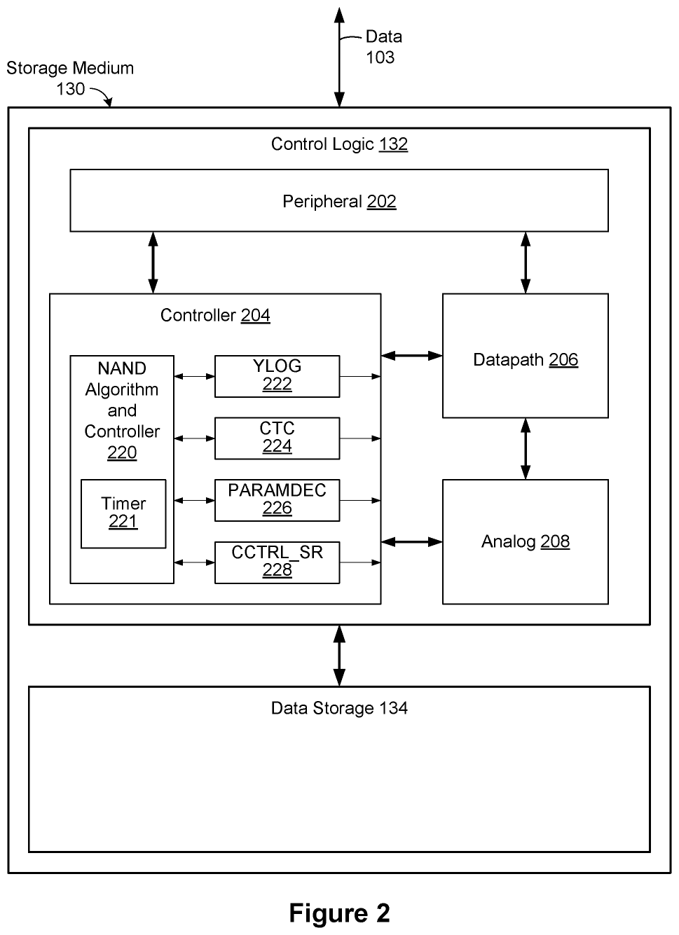

FIG. 2 is a diagram of an implementation of a storage medium 130 as introduced above with reference to FIG. 1 (features shared with FIG. 1 are similarly numbered). While certain specific features are illustrated, those skilled in the art will appreciate from the present disclosure that various other features have not been illustrated for the sake of brevity, and so as not to obscure more pertinent aspects of the example implementations disclosed herein. To that end, as a non-limiting example, the storage medium 130 includes control logic 132 and data storage 134.

The control logic 132 (also referred to herein as core control logic) comprises peripheral circuitry 202, a controller module 204, datapath circuitry 206, and analog circuitry 208. The peripheral circuitry 202 receives data and control signals transmitted by the storage controller 124 (FIG. 1) through the data connections 103 (e.g., as part of read, write, and erase instructions), and transmits data to the storage controller 124 (e.g., data read from the data storage 134). The controller module 204 processes control signals and data received from the storage controller 124 and executes system operations (e.g., temperature acquisition) and memory operations (e.g., read, write, erase) specified by the control signals and data. The datapath circuitry 206 (sometimes referred to herein as the datapath) is a collection of functional units (e.g., arithmetic logic units, multipliers, registers, buses) that perform data processing operations as part of the implementation of the system operations and the memory operations specified for execution by the memory controller 204. The analog circuitry 208 (sometimes referred to herein as the analog) is a collection of voltage and/or current circuits (e.g., charge pumps, converters) for providing particular read, write, and erase voltage levels and/or current levels necessary for performing the various memory operations specified for execution by the memory controller 204.

In some implementations, the controller module 204 is communicatively coupled to memory (sometimes referred to herein as controller memory). The controller memory includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. In some embodiments, the controller memory comprises a non-transitory computer readable storage medium. In some embodiments, the controller memory, or the non-transitory computer readable storage medium of the controller memory, stores the programs, modules, and/or data structures, or a subset or superset thereof, for performing one or more of the operations described in this application with regard to any of the components associated with the storage medium 130.

In some embodiments, the various operations described in this application correspond to sets of instructions for performing the corresponding functions. These sets of instructions (i.e., modules or programs) need not be implemented as separate software programs, procedures or modules, and thus various subsets of these modules may be combined or otherwise re-arranged in various embodiments. In some embodiments, the controller memory may store a subset of modules and data structures. Furthermore, the controller memory may store additional modules and data structures. In some embodiments, the programs, modules, and data structures stored in the controller memory, or the non-transitory computer readable storage medium of the controller memory, provide instructions for implementing any of the methods described herein. Stated another way, the programs or modules stored in the controller memory, when executed by the one or more processors associated with the memory controller 204, cause the storage medium 130 to perform any of the operations described herein. Although FIG. 2 shows various modules, FIG. 2 is intended more as functional description of the various features which may be present in the modules than as a structural schematic of the embodiments described herein. In practice, the programs, modules, and data structures shown separately could be combined, and some programs, modules, and data structures could be separated.

The data storage 134 (also referred to herein as a core, memory core, or core array) comprises one or more memory devices. In some implementations, the memory devices are flash memory cells, and the data storage 134 comprises at least one of NAND-type flash memory and/or NOR-type flash memory. The data storage 134 is often divided into a number of addressable and individually selectable blocks, referred to herein as selectable portions. In some implementations, for flash memory, the individually selectable blocks are the minimum erasable units in a flash memory device. In other words, each block contains a minimum number of memory cells that can be erased simultaneously. Each block is usually further divided into a plurality of pages, where each page is typically an instance of a minimum unit of the smallest individually accessible sub-block in the block. However, in some implementations (e.g., in some types of flash memory), the minimum unit of individually accessible data is a sector, which is a subset of a page. That is, each page contains a plurality of sectors and each sector is the minimum unit of individually accessible data for writing data to or reading data from the flash memory device.

For the sake of notation only, a block of data includes a plurality of pages, typically a fixed number of pages per block, and each page includes a plurality of sectors, typically a fixed number of sectors per page. For example, in some implementations, one block includes 64 pages, 128 pages, 256 pages, or another suitable number of pages. The respective sizes of blocks, pages and sectors are often a matter of design choice or end-user choice, and often differ across a wide range of enterprise and consumer devices. However, for example only, and without limitation, in some enterprise applications a page includes 2K (i.e., 2048) to 16K bytes, and a sector includes anywhere from 256 bytes to 544 bytes. Those ranges may be extended upward or downward, and/or shrink or expand depending on a particular application. In some embodiments, each page stores one or more codewords, where a codeword is the smallest unit of data that is separately encoded and decoded by the encoder and decoder mechanisms of a particular device.

In some implementations, the memory devices included in the data storage 134 are subject to various memory and/or system operations specified by the storage controller 124 and/or the controller module 204. The peripheral circuitry 202 receives operations and data specified by the storage controller 124 through the data connections 103, routes the operations to the controller module 204, and routes the data to the datapath 206. The controller module translates the operation signals to lower level signals which implement the specified operations at the data storage 134. For example, an operation received by the peripheral circuitry 202 may be a read operation; the controller module 204 would translate the read operation to one or more signals, including a read voltage for applying to a specific word line of a memory device in the data storage 134, the application of which would allow the control logic 134 to read the memory device in accordance with the specified read operation.

In some implementations, the control logic 132 is implemented as a Circuit Under Array (CuA) to reduce the form factor of the storage medium. That is, if the core array (data storage 134) is a three dimensional array of memory devices, the core control logic 132 is implemented as a layer within the array (e.g., as the bottom layer, under the array). This implementation has the benefit of not requiring horizontal space on which to implement control logic. However, as the form factor for storage mediums continues to shrink, it becomes more difficult to access the control logic for purposes of rework, otherwise referred to herein as engineering change orders (ECOs). For example, the NAND memory manufacturing process may include two tape-out phases—Active area Tape-out (AATO) and Metal Tape-out (MTO). If an issue is discovered after the storage medium 130 has been manufactured, it can be addressed even after the AATO by using dummy gates and re-routing the metal lines. If a bug is found or the specification is modified after AATO/MTO, the control logic 132 can be fixed by an ECO, which involves changing the Metal Layer mask for the chip fabrication. This whole process of fixing the bugs or updating the design is sometimes referred to as a revision.

Upon fabrication of a chip containing the storage medium 130, a logic verification team may check the control logic and functionality of the controller module 204. In some implementations, the controller module 204 is the logic part of the chip containing the storage medium 130, and it contains a plurality of sub-modules like timer 221, sub-module controller (NACM) 220, memory column controller (YLOG) 222, Core Timing Chart module (CTC) 224, Operation parameters module (PARAMDEC) 226, and data transfer controller (CCTRL_SR) 228.

In some implementations, sub-module controller 220 may refer to a controller for sub-modules such as YLOG 222, CTC 224, PARAMDEC 226 and CCTRL_SR 228. NACM 220 may decode the commands set by the user/peripheral into different operations like read, program or erase. Depending on the operation, NACM 220 may trigger corresponding logic modules (sometimes referred to herein as finite state machines (FSM)) for different modes. For example, if the operation is a program operation, NACM 220 may trigger a Program FSM followed by a Verify FSM. NACM 200 may also include an inbuilt TIMER module 221 which configures the different clocks depending on the FSM which is triggered. For example, for a Program FSM, TIMER 221 may set the main clocks as pre-charge clock (P_CLK), followed by program operation clock (PD_CLK), followed by recovery clock (PR_CLK). Each of these main clocks may be divided into different sub-clocks. Different control logic may be implemented in each of the sub-clocks. NACM 220 may provide the different mode operations which are to be executed and different clocks (in which each of these operations are to be executed) to all of the sub modules.

CTC 224 may refer to an implementation of a chart that identifies the basis on which operations are executed. CTC 224 may refer to a group of signals which are set or reset during different sub-clocks depending on whether a condition is true or false. On the basis of these signals (if a signal is set or reset), different tasks may be executed. As used herein, “reset” may refer to an implementation of maintaining a signal in its default state. As used herein, “set” may refer to an implementation of inverting or changing a state of a signal from its default state. For example, if a default state of a signal A is logic 0, then “setting” the signal A comprises changing the signal to logic 1, and “resetting” the signal A comprises changing the signal to logic 0. Likewise, “resetting” a signal A which is already in its default state comprises maintaining the default state of the signal (e.g., keeping the signal A at logic 0), and “setting” a signal A which is already in a state other than the default state comprises maintaining the state of signal A in the state other than the default state (e.g., keeping the signal A at logic 1). As used herein, a “condition” may refer to one or more requirements for operating a signal in a given mode with a specific parameter set. For example, condition A is set for a particular signal if the memory is in read mode and if a read parameter is logic 1.

Operation parameters module (PARAMDEC) 226 may generate digital voltages which may be required during different operations like read, program and erase. These digital voltages may be inputs to charge pumps which convert digital voltages to analog values for driving the core circuitry.

Data transfer controller (CCTRL_SR) 228 generates a data transfer protocol (including clocks and bits) between the controller 204 and the data storage 134. Bits in this context may refer to an encoded format of different driver voltages for application to the core circuitry during a read, program or erase operation.

Memory column controller (YLOG) 222 may control the column side of data storage 134. YLOG 222 may control the column address, skip the bad columns, and/or any logical operation required for the data that is transferred to/from data storage 134.

As part of the verification process, controller module inputs and outputs are matched with the specification for each sub-module. After logic verification closure metrics are met, it is assumed that the storage medium 130 has functionally passed the verification process and the design is approved for fabrication. However, if logic verification closure metrics are not met, design engineers may wish to change the design. For example, after checking the final silicon, a design engineer may determine that a normal program operation needs more time to complete, and the solution may include increasing the program pulse. To facilitate this solution, some signals may need to be modified at the sub-module level, which will further affect the program time or any other final output. An ECO is done to compensate for these changes. After the storage medium (e.g., the NAND) is fabricated, it is tested again and matched with the expected behavior seen in pre-silicon simulations. Any additional mismatches are debugged, and alternative changes are suggested as a result of the debugging, which may lead to additional ECOs.

ECOs and tape-outs are a costly process, and it becomes even more costly and complicated as the form factor of the storage medium is minimized. At some point, it becomes cost-prohibitive to implement design changes on the fly, making it necessary instead to redesign the whole chip containing the storage medium. As such, there is a motivation to implement some or all of the control logic 132 in general, and the controller module 204 specifically, in software (also referred to as firmware in this context), rather than in hardwired circuitry. In some implementations, the various sub-modules 220, 222, 224, 226, 228 of the controller module 204 are implemented in separate firmware modules. Alternatively, one or more of the various sub-modules may be combined and implemented in the same firmware module.

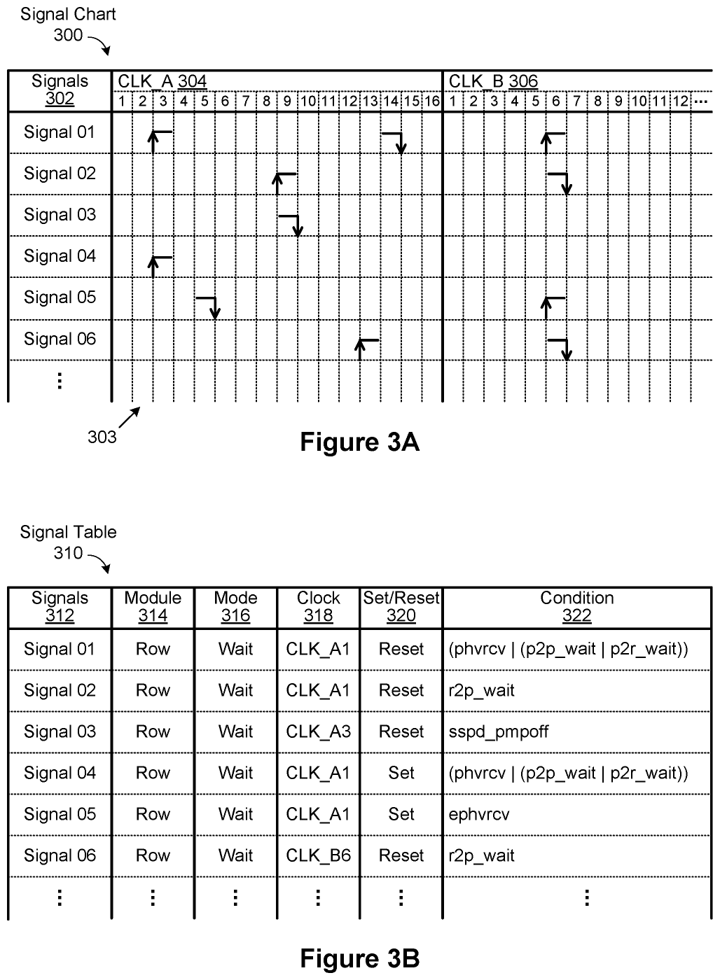

FIG. 3A is a signal chart 300 depicting a plurality of signals 302 (e.g., signals as described above in the context of performing memory operations at the control logic level) and various signal changes 303. The signals represent parameters which specify particular voltages for performing memory operations, such as read, write, and/or erase operations (e.g., a particular read voltage to be applied to a word line of a specified memory cell). Various combinations of signals specify voltage variations and combinations of voltages for application to particular memory devices and groups of memory devices specified by the memory operations. Stated another way, the signal specification depicted in the chart 300 specifies dynamic conditions for each signal which suggest, when true, whether to set or reset a respective signal value. The signals control the analog circuitry (208, FIG. 2) by specifying which voltage levels the analog circuitry should apply to which memory cells as part of the implementation of the various memory operations. The chart 300 specifies signal changes (e.g., high-to-low, low-to-high) according to various clocks (e.g., Clock A 304 and Clock B 306), with each clock being separated into sub-clock cycles (e.g., cycles 1-16). Each sub-clock cycle represents a time-division-multiplexed mode (e.g., single level cell (SLC) read, multiple level cell (MLC) read, SLC program, MLC program, and so forth). As an example, sub-clock cycle 1 of CLK_A may be used for or otherwise associated with SLC read operations, sub-clock cycle 2 of CLK_A may be used for or otherwise associated with MLC read operations, and so forth.

The signal specifications in the chart 300 may be implemented in hardwired combinational logic blocks. In such implementations, the combinational logic required to implement a signal specification such as the one in chart 300 could have as many as 25 modes or more (with each mode being further divided by sub-clock), more than 500 unique inputs, more than 500 parameters, and more than 100 signals as outputs. A firmware-based implementation (e.g., such as a microcontroller unit (MCU) implementation) of the signal specifications embodied in the chart 300 (as opposed to hardwired combinational logic) would necessitate storing these parameters, inputs, and output specifications in memory (e.g., RAM or ROM).

FIG. 3B is a signal table 310 depicting a firmware-based implementation of the signal specification depicted in the chart 300. The table 310 includes at least a plurality of signals 312 corresponding to the signals 302, module data 314, mode data 316, clock data 318, set/reset data 320, and condition data 322. For example, the table specifies module, mode, clock, and set-reset specifications for a given signal, and these specifications are implemented in accordance with the results of condition evaluations (conditions 322). If a given condition is determined to be true, then a corresponding signal acting on a particular row 314, for a particular mode 316, using a particular clock 318, would be set or reset in accordance with the set/reset data 320.

In some implementations, the signal specification as depicted in the table 310 is stored in memory (e.g., RAM and/or ROM). However, the amount of memory required for storing the more than 500 unique inputs, more than 500 parameters, and more than 100 signals associated with a signal specification as depicted in the table 310 would be prohibitively large. For instance, such a table 310 could require as many as 6,000 entries or more. As such, the following discussion details various implementations for optimizing the memory required to store the various parameters, inputs, and outputs specified in the signal chart 300 in the context of a firmware-based implementation of core controller logic (e.g., sub-module 228, FIG. 2) for a storage medium 130. The optimizations discussed below allow for various firmware-based implementations of core controller logic with little to no timing penalties, a very low memory (RAM/ROM) footprint, and very low power consumption (e.g., low control current) since most of the code may reside in ROM, rather than being implemented in hardwired logic circuitry.

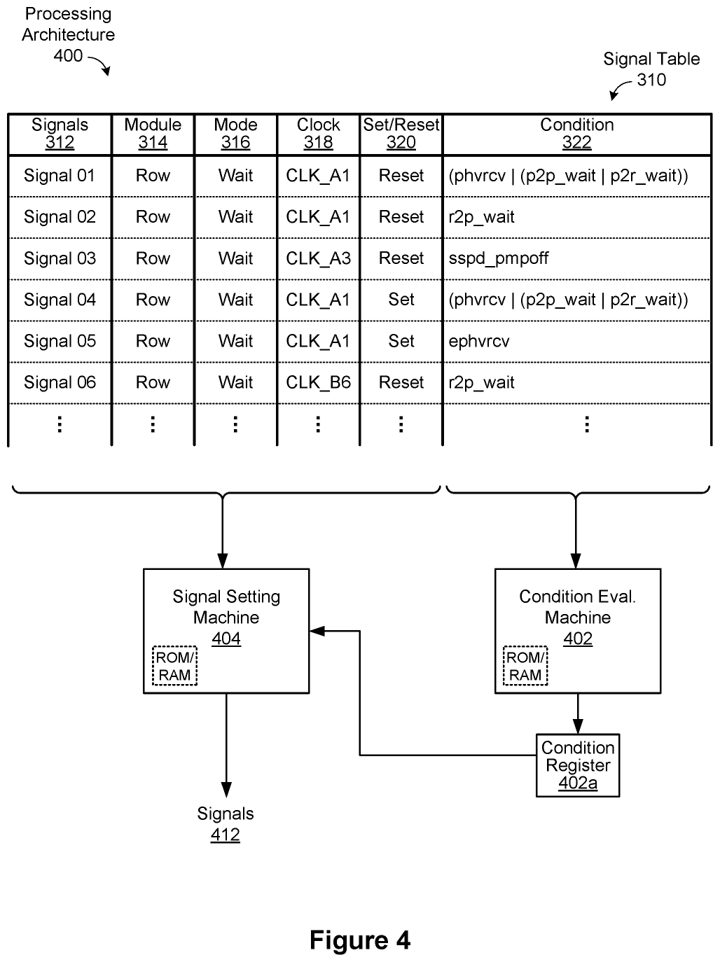

FIG. 4 is a diagram of a processing architecture 400 in accordance with some embodiments. The processing architecture 400 is configured to optimize the implementation of the signal specifications as depicted in the table 310 (similar features are similarly labeled) by splitting the processing into two distinct processing modules (also referred to herein as machines). In some implementations, each processing module comprises or is otherwise implemented by microcontroller (MCU) circuitry and memory (e.g., RAM and/or ROM) including instructions for performing the operations described herein.

In some implementations, the processing architecture includes a condition evaluation machine 402 and a signal setting machine 404. The condition evaluation machine 402 is configured to determine the conditions 322 are met, and the signal setting machine 404 is configured to set or reset signal 312 corresponding to the conditions 322 in accordance with the determination regarding whether the conditions 322 are met. Stated another way, the condition evaluation machine 402 determines that a particular condition 322 is met, then the signal setting machine 404 sets or resets an associated signal 312. By splitting the table 310 into a condition processing component (the condition evaluation machine 402) and a signal processing component (the signal setting machine 404), each component can be separately optimized to use less memory. In addition, each machine has faster throughput. Conditions are processed by one machine (402) and determinations regarding which signals should be set or reset are processed by the other machine (404) in a way that is more efficient than coupling the condition and signal processing into a single processing module.

In some implementations, the condition processing and the signal processing are asynchronous. That is, the condition evaluation machine 402 processes conditions 322 and the signal setting machine 404 processes signals 312 based on those conditions without requiring parallel condition processing. In some implementations, the condition evaluation machine 402 evaluates conditions 322 and stores the results of the condition evaluations as a one-dimensional (1-bit) condition array, for example, in a register 402a. The signal setting machine 404 uses the condition evaluation results 402a as a basis for setting or resetting signals 312, and outputs the resulting set/reset signals 412.

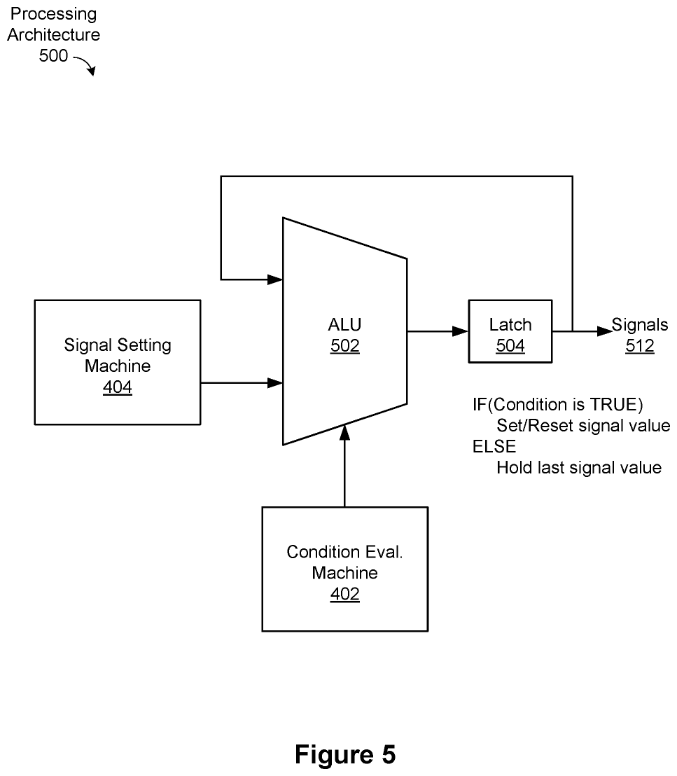

FIG. 5 is a diagram of a processing architecture 500 including an optimization of the processing architecture 400 in accordance with some embodiments. In some implementations, the signal setting machine 404 only sets or resets a signal if the corresponding condition is found to be true (by the condition evaluation machine 402). If the condition is not found to be true, then the signal setting machine 404 holds the last signal value. By only setting or resetting signals when corresponding conditions are true, the amount of memory required to store signal data is minimized, since the signal data which is held from a previous value does not require additional storage. This optimization may be implemented with an arithmetic logic unit (ALU) 502 and a latch 504. In some implementations, the ALU 502 is a functional ALU implemented in firmware, and/or the latch 504 is a functional latch implemented in firmware. When the condition evaluation machine 402 determines a particular condition is true, this result enables the ALU 502, which passes the set/reset result from the signal setting machine 404 to the latch 504, which outputs the set/reset signal 512. If the condition evaluation machine 402 determines a particular condition to not be true, this result disables the ALU 502, which does not pass the set/reset result from the signal setting machine 404 as a result.

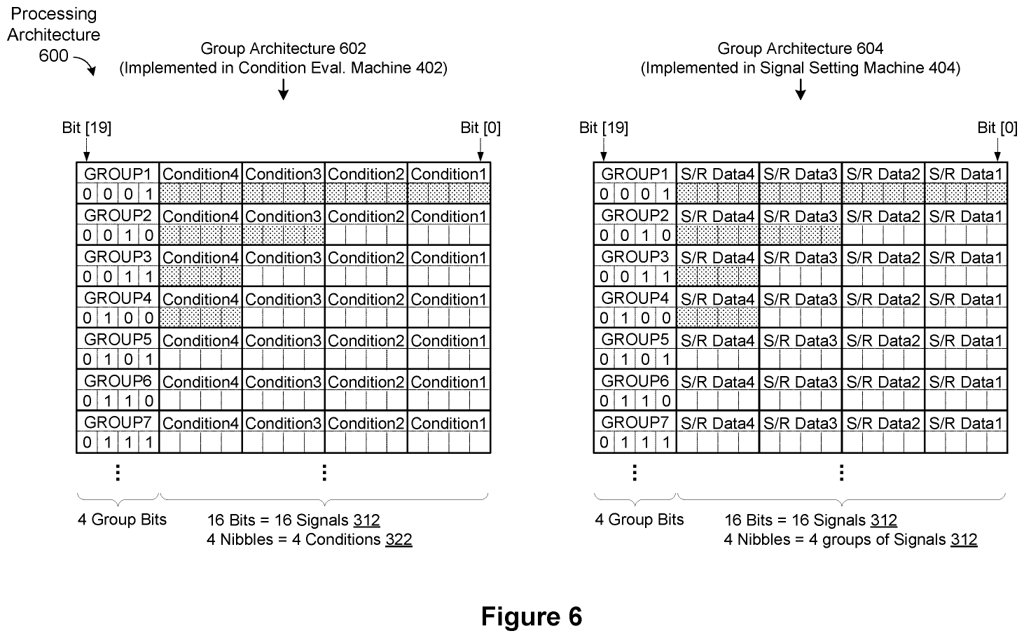

FIG. 6 depicts a processing architecture 600 in accordance with some embodiments. The processing architecture 600 optimizes the architecture(s) 400 and/or 500 by grouping conditions and signals according to mathematical correlations. Since there may be as many as 140 output signals or more, optimizations may be realized by grouping highly coordinated signals and processing conditions and set/reset operations on the signal groups, rather than processing the conditions and set/reset operations on individual signals. In some implementations, groups may include 10-16 signals. Groups may include more signals or less signals; the numbers 10 and 16 are used for discussion purposes and are not meant to be limiting.

The signals are grouped together based on mathematical correlation, rather than functionality. Stated another way, signals which are correlated to similar condition results may be grouped together, or signals which are correlated in their set/reset operations may be grouped together. A basis for the correlation may be behavior of the signals (e.g., timing of “set” and “reset” transitions) in any operation. Signals exhibiting similar behavior in most operations are determined to be correlated, and are accordingly grouped together.

In some implementations, a signal group architecture 604 includes a plurality of groups of signals. Each group represents respective signals with respective bits. Together with group bits, each group of 16 signals is represented by 20 bits (4 group bits and 16 signal bits). In some implementations, signal groups are further divided into subgroups. In some implementations, groups of 16 signals are divided into 4 subgroups, each subgroup representing 4 signals. Groups may be divided into more or fewer subgroups, and subgroups can include more or fewer signals; the numbers 4 and 4 are used for discussion purposes and are not meant to be limiting. In the example group architecture 604 depicted in FIG. 6, each group includes 16 signals 312, represented by 16 bits, and each group of 16 signals includes 4 subgroups of 4 signals, each subgroup represented by a nibble (4 bits).

Likewise, in some implementations, a condition group architecture 602 includes a plurality of groups of conditions. Each group represents respective conditions with respective bits. Together with group bits, each group of 16 conditions is represented by 20 bits (4 group bits and 16 condition bits). In some implementations, condition groups are further divided into subgroups. In some implementations, groups of 16 conditions are divided into 4 subgroups, each subgroup representing 4 conditions. Groups may be divided into more or fewer subgroups, and subgroups can include more or fewer conditions; the numbers 4 and 4 are used for discussion purposes and are not meant to be limiting. In the example group architecture 602 depicted in FIG. 6, each group includes 16 conditions 312, represented by 16 bits, and each group of 16 signals includes 4 subgroups of 4 signals, each subgroup represented by a nibble (4 bits).

The group architecture 602 is implemented in or by the condition evaluation machine 402, and the group architecture 604 is implemented in or by the signal setting machine 404. Therefore, when the condition evaluation machine 402 determines a particular condition is true, the condition evaluation machine 402 passes this determination to the signal setting machine 404, which sets or resets a corresponding signal accordingly. If the condition evaluation machine 402 determines a particular condition to not be true, the condition evaluation machine 402 passes this determination to the signal setting machine 404, which holds the corresponding signal at its previous value.

In some implementations, each subgroup represents a single group-wise condition. As such, if a particular condition is determined by the condition evaluation machine 402 to be true, then the four signals in the corresponding signal subgroup are set or reset accordingly. Otherwise, the four signals in the corresponding subgroup are held to their previous values.

In some implementations, condition and signal subgroups are arranged within a group such that subgroups which are frequently changing (being set or reset) are grouped closer to the left (higher bits), and subgroups which are less frequently changing are grouped closer to the right (lower bits).

In the example condition group architecture 602 in FIG. 6, condition nibbles 1-4 in group 1, nibbles 3-4 in group 2, nibble 4 in group 3, and nibble 4 in group 4 are determined by the condition evaluation machine 402 to be true (and represented by shaded bits). In accordance with these determinations, the signals represented by nibbles 1-4 in group 1, nibbles 3-4 in group 2, nibble 4 in group 3, and nibble 4 in group 4, are set or reset according to the signal specifications 312-320 (FIG. 4) by the signal setting machine 404.

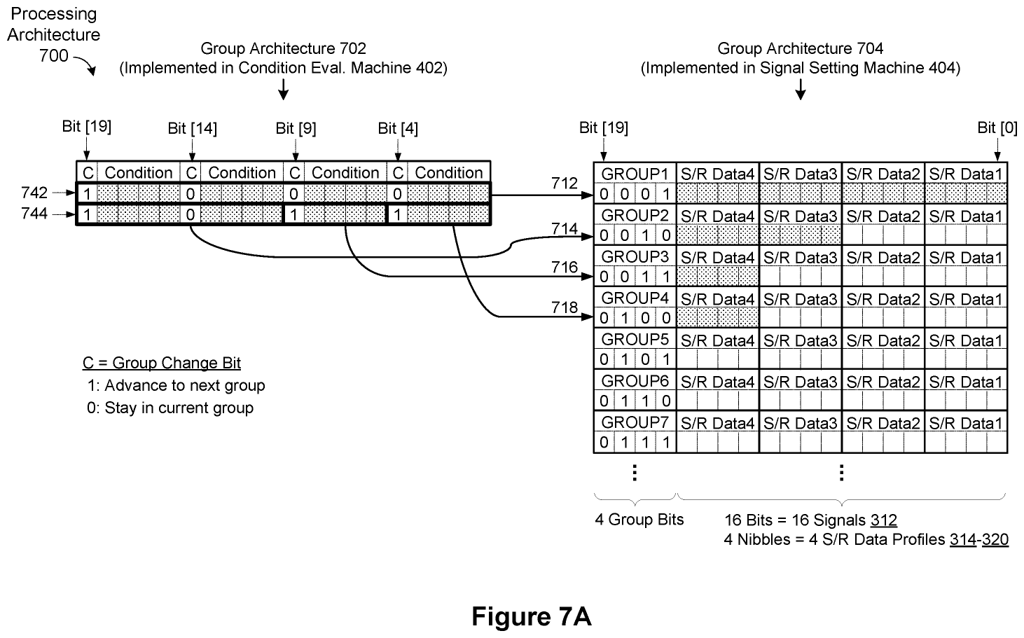

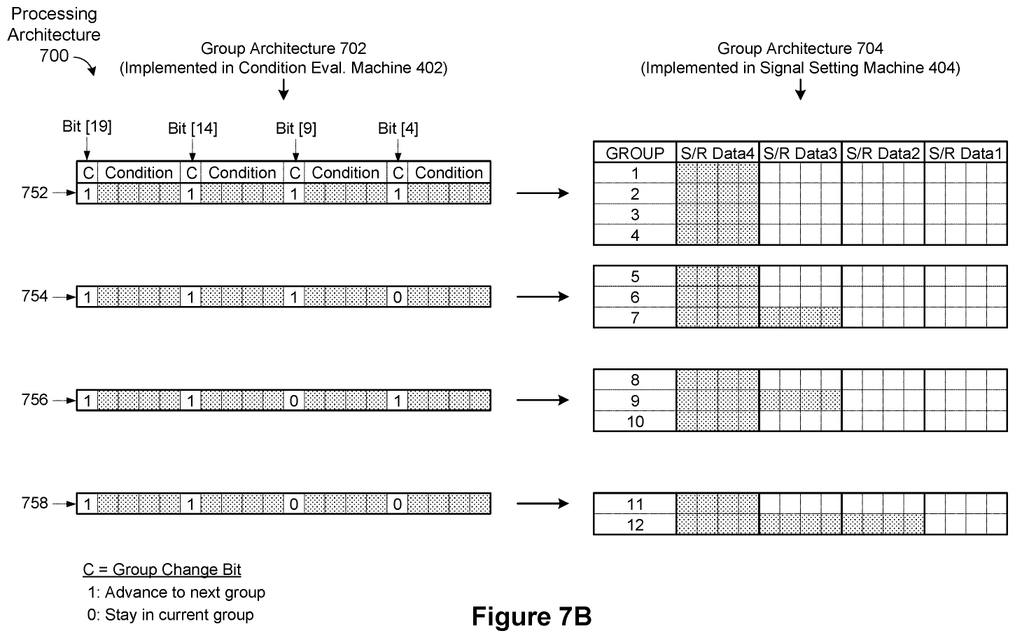

FIG. 7A depicts a processing architecture 700 in accordance with some embodiments. The processing architecture 700 further optimizes condition group storage and processing such that condition data requires less memory. The processing architecture 700 includes a signal group architecture 704 which corresponds to the signal group architecture 604 (FIG. 6). However, the processing architecture 700 includes a condition group architecture 702 which is an optimized version of the condition group architecture 602. The group architecture 702 stores only those conditions which are determined by the condition evaluation machine 402 to be true, or to have been otherwise met. The true conditions are depicted as shaded bits in the figure (and therefore, all of the condition bits in the group architecture 702 are shaded).

The group architecture 702 includes group change bits (denoted with an uppercase C). Each condition subgroup is associated with a change bit C. In the example group architecture 702, bits 4, 9, 14, and 19 are reserved for group change bits C, while the other bits represent condition data. If a group change bit C is asserted (binary 1), then the associated condition applies to a corresponding subgroup of signals in a new group. If the group change bit C is not asserted (binary 0), then the associated condition applies to a corresponding subgroup of signals in the same group as the previous subgroup. For example, change bit 19 is asserted; therefore, the associated condition data (bits 15-18 in group 742) apply to SR Data4 in group 1 in the group architecture 704. The next three change bits are not asserted (bits 14, 9, and 4); therefore, the associated condition data (bits 10-13, 5-8, and 0-3) correspond with SR Data3, Data2, and Data1 in the same group (Group 1) as the previous subgroup (SR Data4). Thus, the four conditions in group 742 of the condition group architecture 702 are mapped to the four signal subgroups in Group 1 of the signal group architecture 704 (the mapping is denoted by line 712). Continuing with this example, the first two condition subgroups in group 744 are mapped to Data4 and Data3 of Group 2 of the signal group architecture 704 (denoted by line 714) because the first condition subgroup change bit (bit 19) is asserted (advancing the mapping to the next signal group) and the second subgroup change bit (bit 14) is not asserted (thereby remaining in the same signal group). The third and fourth condition subgroups are mapped to Data4 of Groups 3 and 4, respectively, of the signal group architecture 704 (denoted by lines 716 and 718, respectively), because each condition change bit (bits 9 and 4) is asserted, thereby advancing the mapping to a new signal group for each condition subgroup.

FIG. 7B depicts further examples of the processing architecture 700 described above with reference to FIG. 7A. Each condition subgroup in condition group 752 maps to a signal subgroup in a new signal group (Data4 in Groups 1, 2, 3, 4) in the group architecture 704 (since change bits 19, 14, 9, 4=1). The first three condition subgroups in condition group 754 map to new signal groups (Data4 in Groups 5, 6, 7) (since change bits 19, 14, 9=1), while the fourth condition subgroup maps to the next subgroup in the current signal group (Data3 in Group 7) (since change bit 4=0). The first two condition subgroups in group 756 map to new signal groups (Data4 in Groups 8, 9) (since change bits 19, 14=1), the third condition subgroup maps to the current signal group (Data3 in Group 9) (since change bit 9=0), and the fourth condition subgroup maps to a new signal group (Data4 in Group 10) (since change bit 4=1). The first two condition subgroups in group 758 map to new signal groups (Data4 in Groups 11, 12) (since change bits 19, 14=1), and the third and fourth condition subgroups map to the current signal group (Data3 and Data2 in Group 12) (since change bits 9, 4=0). In these examples and in those that follow, condition data being “mapped” to signal data means the signal setting machine 404 will set or reset a particular signal in accordance with a condition determination (by the condition evaluation machine 402) for a corresponding condition. The corresponding condition data can be described as being “mapped” to the particular signal data. Condition data which is not “mapped,” or is otherwise not passed to the signal setting machine 404, is held at its previous value, and the corresponding signals are held at their previous values.

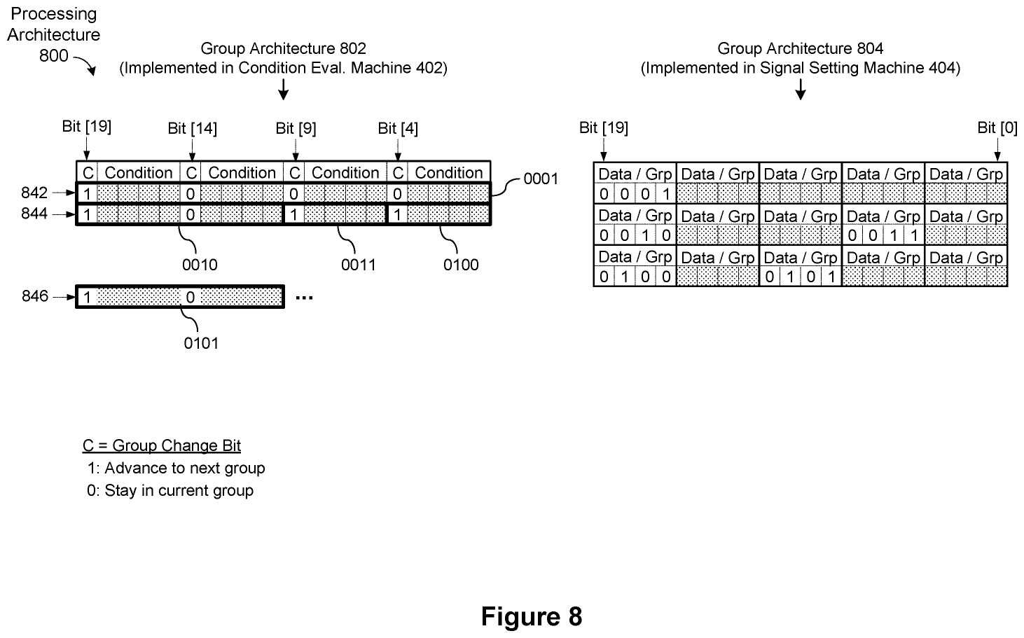

FIG. 8 depicts a processing architecture 800 in accordance with some embodiments. While the processing architecture 700 optimized condition group storage and processing, the processing architecture 800 optimizes signal group storage and processing such that the signal data requires less memory. The processing architecture 800 includes a condition group architecture 802 which corresponds to the condition group architecture 702 (FIG. 7A). However, the processing architecture 800 includes a signal group architecture 804 which is an optimized version of the signal group architecture 704. The group architecture 804 stores (or otherwise processes, generates, or sends) only those signals which are determined by the signal setting machine 404 to be different from a previous state (in other words, determined to have changed). The changed signals are depicted as shaded bits in the figure (and therefore, all of the signal bits in the group architecture 804 are shaded). Data representing signals which have not changed does not need to be stored, processed, generated, or sent, since those signals retain their previous values.

The group architecture 804 includes four subgroups in Group 1 (corresponding to the four conditions in row 842), two subgroups in Group 2 (corresponding to the first two conditions in row 844), one subgroup in Group 3 (corresponding to the third condition in row 844), and one subgroup in Group 4 (corresponding to the fourth condition in Group 4). This architecture reduces the amount of memory necessary to store signal data. For example, the same signal data required four 19-bit groups of data for storage (76 bits total) in architecture 700 (FIG. 7A). However, in architecture 800 (FIG. 8), this data only requires 46 bits of storage. Any extra unused space may be used for subsequent signals. For example, two additional conditions (row 846) may be mapped to two subgroups in Group 5 of the signal group architecture 804.

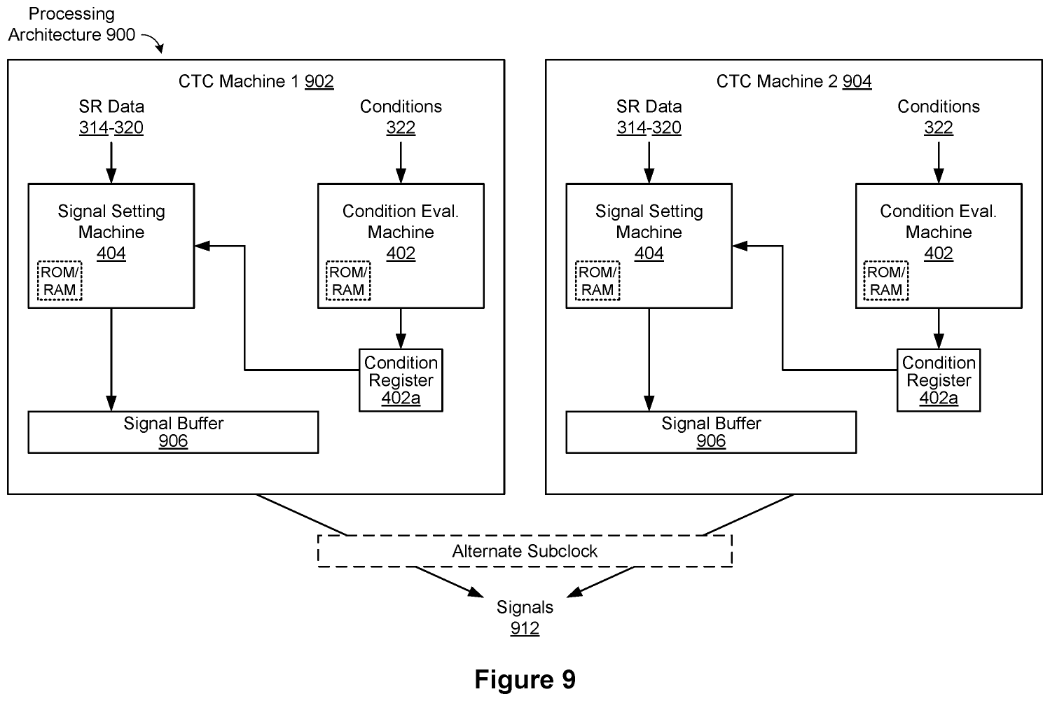

FIG. 9 depicts a processing architecture 900 in accordance with some embodiments. The processing architecture includes two core control machines 902 and 904, processing conditions and signals in parallel. Each core control machine corresponds with the processing architecture(s) described above with reference to FIGS. 4-8 (similar features are similarly labeled). Stated another way, each core control machine 902 and 904 processes conditions and signals as described above with reference to one or more of FIGS. 4-8. While the processing architectures described with reference to FIGS. 4-8 provide for optimized memory (e.g., reduced memory requirements and smaller memory footprints), the processing architecture 900 described with reference to FIG. 9 provides for optimized timing. Specifically, rather than process conditions and signals with a single instance of the condition evaluation machine 402 and signal setting machine 404, the processing architecture 900 includes a second instance of the condition evaluation machine 402 and signal setting machine 404 configured to process conditions and signals in parallel. In some implementations, each machine 902 and 904 outputs processed signals to a respective signal buffer 906, and the resulting signals 912 are fetched from each buffer 906 according to an alternating subclock. For example, if each individual machine (902/904) requires two clock cycles to process signals 912, the processing architecture 900 generates a signal 912 for each clock signal, alternating between each respective signal buffer 906. Stated another way, while one machine (902) prepares signal data for a current clock cycle, the other machine (904) prepares signal data for the next clock cycle. This way, timing violations are reduced since each machine is given enough time to decode and process signal data for memory operations while the system as a whole provides the signal data more quickly than each individual machine could on its own.

The optimized processing architectures described above provide for reduced memory footprints with no cost to timing or power. For instance, in some implementations, the RAM/ROM footprint requirement for firmware implementations of the control logic described above may be as low as 15 kilobytes (KB) or lower, compared to as much as 90 KB or more without the optimizations described above. More specifically, an example firmware implementation of the signal chart 300 may require 200 KB of memory. By optimizing the firmware implementation with the processes described above with reference to FIGS. 4 and 5 (i.e., separate machines for signal and condition processing), the memory requirement may be reduced by a factor of ten, from 200 KB to 20 KB. Further, the optimizations described above with reference to FIGS. 6-8 (i.e., subgroups and data compaction) may further reduce the memory requirement by another factor of ten, down to approximately 2 KB in some implementations. Lastly, the parallel processing optimization described above with reference to FIG. 9 allows for the implementations described above with reference to FIGS. 4-8 to be implemented without incurring any timing violations.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” and “approximately” may refer to + or −10% of the value referenced. For example, “about 9” is understood to encompass 8.1 and 9.9.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A data storage system, comprising:
a storage controller; and
a storage medium in communication with the storage controller, the storage medium comprising:
a memory core comprising an array of memory cells; and
core control logic configured to perform operations on memory cells in the array in accordance with instructions received from the storage controller;
wherein the core control logic comprises:
a firmware-implemented condition evaluation machine configured to determine whether a plurality of memory core conditions are met; and
a firmware-implemented signal setting machine configured to set or reset a plurality of respective memory operation signals to implement the operations on the memory cells based on respective condition evaluation machine determinations.

2. The data storage system of claim 1, wherein the memory core conditions are based on states of memory cells in the array.

3. The data storage system of claim 1, wherein the core control logic is configured to perform a respective operation on a memory cell in the array by asserting a respective memory operation signal.

4. The data storage system of claim 3, wherein:
performing a respective operation on a memory cell comprises asserting a particular voltage on a word line of the memory cell; and
the memory cell is specified by one or more of the instructions received from the storage controller.

5. The data storage system of claim 1, wherein the operations on memory cells in the array include one or more of a read operation, a write operation, and/or an erase operation.

6. The data storage system of claim 1, wherein the signal setting machine is configured to:
set or reset the plurality of respective memory operation signals in accordance with a corresponding condition being met based on a respective condition evaluation machine determination; and
forego setting or resetting the plurality of respective memory operation signals in accordance with a corresponding condition not being met based on a respective condition evaluation machine determination.

7. The data storage system of claim 1, wherein:
the signal setting machine is configured to set or reset the plurality of respective memory operation signals by setting or resetting correlated groups of memory operation signals; and
the correlated groups of memory operation signals are arranged in accordance with correlations in signal behavior when evaluated under similar conditions.

8. The data storage system of claim 7, wherein:
the condition evaluation machine is configured to determine whether a respective memory core condition of the plurality of memory core conditions is met; and
the signal setting machine is configured to set or reset a respective group of memory operation signals based on the determination of whether the respective memory core condition is met.

9. The data storage system of claim 7, wherein the condition evaluation machine is configured to:
store condition determination results for memory core conditions which are met; and
forego storing condition determination results for memory core conditions which are not met.

10. The data storage system of claim 9, wherein the condition evaluation machine is configured to:
determine whether a current condition evaluation result corresponds with a current group of memory operation signals;
include a group change indicator in the stored condition determination results in accordance with a determination that the current condition evaluation results correspond with a new group of memory operation signals; and
forego including a group change indicator in the stored condition determination results in accordance with a determination that the current condition evaluation results corresponds with a current group of memory operation signals.

11. The data storage system of claim 10, wherein the signal setting machine is configured to:
set or reset a new group of memory operation signals in accordance with a stored condition evaluation result which includes a group change indicator; and
set or reset a current group of memory operation signals in accordance with a stored condition evaluation result which does not include a group change indicator.

12. The data storage system of claim 9, wherein the signal setting machine is configured to:
store signal data for signals that have been set or reset in accordance with memory core conditions having been met; and
forego storing signal data for signals that have not been set or reset in accordance with memory core conditions which have not been met.

13. The data storage system of claim 1, wherein the core control logic further comprises:
a second firmware-implemented condition evaluation machine configured to determine whether a plurality of memory core conditions are met; and
a second firmware-implemented signal setting machine configured to set or reset a plurality of respective memory operation signals based on respective condition evaluation machine determinations.

14. The data storage system of claim 13, wherein:
each condition evaluation machine is configured to evaluate conditions in accordance with timing specified by alternate subclock cycles; and
each signal setting machine is configured to set or reset memory operation signals in accordance with timing specified by the alternate subclock cycles.

15. A method, comprising:
at a data storage system comprising a storage controller and a storage medium in communication with the storage controller, the storage medium comprising (i) a memory core comprising an array of memory cells and (ii) core control logic configured to perform operations on memory cells in the array in accordance with instructions received from the storage controller:
determining whether a plurality of memory core conditions are met; and
setting or resetting a plurality of respective memory operation signals to implement the operations on the memory cells based on respective condition evaluation machine determinations.

16. A data storage system, comprising:
a storage controller; and
a storage medium in communication with the storage controller, the storage medium comprising:
a memory core comprising an array of memory cells; and
core control logic configured to perform operations on memory cells in the array in accordance with instructions received from the storage controller;
wherein the core control logic comprises:
condition evaluation means for determining whether a plurality of memory core conditions are met; and
signal setting means for setting or resetting a plurality of respective memory operation signals to implement the operations on the memory cells based on respective condition evaluation machine determinations.

17. The data storage system of claim 16, wherein the memory core conditions are based on states of memory cells in the array.

18. The data storage system of claim 16, wherein the core control logic is configured to perform a respective operation on a memory cell in the array by asserting a respective memory operation signal.

19. The data storage system of claim 18, wherein:
performing a respective operation on a memory cell comprises asserting a particular voltage on a word line of the memory cell; and
the memory cell is specified by one or more of the instructions received from the storage controller.

20. The data storage system of claim 16, wherein the operations on memory cells in the array include one or more of a read operation, a write operation, and/or an erase operation.
